(19) United States
(12) Patent Application Publication
(10) Pub. No.: US 2016/0121792 A1
(43) Pub. Date: May 5, 2016

(54) TRAILER LIGHT DIAGNOSTIC DEVICE

(71) Applicant: JS Products, Inc., Las Vegas, NV (US)

(72) Inventors: Michael D. Christopherson, Clinton, UT (US); F. Javier Hernandez, Las Vegas, NV (US); James E. Moore, Las Vegas, NV (US)

(21) Appl. No.: 14/931,793

(22) Filed: Nov. 3, 2015

Related U.S. Application Data
(60) Provisional application No. 62/074,402, filed on Nov. 3, 2014.

(51) Int. Cl. B60Q 11/00

(52) U.S. Cl. CPC B60Q 11/005

(57) ABSTRACT

A device and system are disclosed for trailer light diagnostics. The device includes, in one embodiment a housing, and a controller disposed within the housing and configured for wirelessly communicating a status of an electrical wire of a vehicle lighting system with a remote display, where the controller is electrically coupled with the wire. The system includes the device and the remote display configured for performing actions including establishing a wireless data connection with the trailer light diagnostic device, receiving, from the trailer light diagnostic device, data indicative of a electrical status of a wire in the trailer light system, and presenting, in response to the electrical status of the wire, a notification to a user.

### CROSS-REFERENCES TO RELATED APPLICATIONS

This application claims the benefit of and claims priority to U.S. Provisional Patent Application Number 62/074402 entitled “TRAILER LIGHT DIAGNOSTIC DEVICE” and filed on Nov. 3, 2014 for Michael D. Christopherson et al., which is incorporated herein by reference.

### FIELD

This invention relates to vehicle and trailer lighting systems and more particularly relates to a diagnostic tool for generating notifications of circuit statuses.

### BACKGROUND

Most vehicles capable of towing a trailer are equipped with a lighting system that is coupled with a wiring harness. Depending on different factors, this wiring harness may have 4, 5, 6, 7, or more connection points. Each connection point is coupled with a different circuit that is useful for energizing, for example, the left turn signal, the right turn signal, the brake lights, the reverse lights, trailer brakes, etc.

Trailer lighting systems, however, are prone to failure for a variety of different reasons. Determining that the trailer lighting system has experienced a failure is often a difficult task, and usually not noticeable once the vehicle and trailer are underway.

### SUMMARY

A device and system are disclosed for trailer light diagnostics. The device includes, in one embodiment a housing, and a controller disposed within the housing and configured for wirelessly communicating a status of an electrical wire of a vehicle lighting system with a remote display, where the controller is electrically coupled with the wire.

In one embodiment, the housing comprises an exterior profile configured for inserting into a wiring harness of the vehicle. The controller comprises a communication interface configured for transmitting the status of the electrical wire. The controller may include a voltage detector configured to detect a voltage of the electrical wire, and a current of the electrical wire.

In one embodiment, the remote display is configured to generate a user interface that includes a depiction of a vehicle, and may be further configured to generate an indication of the status of the electrical wire. In one embodiment, the notification is a visual notification. Alternatively, the notification is an aural notification.

The system includes the device and a remote display configured for performing actions including establishing a wireless data connection with a trailer light diagnostic device, receiving, from the trailer light diagnostic device, data indicative of a electrical status of a wire in a trailer light system, and presenting, in response to the electrical status of the wire, a notification to a user.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates one embodiment of a trailer light diagnostic system in accordance with embodiments of the disclosure;

FIG. 2 is a schematic block diagram illustrating one embodiment of a diagnostic device in accordance with embodiments of the disclosure;

FIG. 3 is a perspective view diagram illustrating one embodiment of a diagnostic device in accordance with embodiments of the disclosure;

FIG. 4 is a side view diagram illustrating one embodiment of a diagnostic device in accordance with embodiments of the disclosure;

FIG. 5 is a perspective view diagram illustrating one embodiment of a housing in accordance with embodiments of the disclosure;

FIG. 6 is a block diagram illustrating one embodiment of a user interface of a remote display in accordance with embodiments of the disclosure;

FIG. 7 illustrates one embodiment of a method for a diagnostic device;

FIG. 8 is a diagram of one embodiment of a computer system for a remote display;

FIG. 9 is a schematic block diagram illustrating one embodiment of a circuit in accordance with embodiments of the present disclosure; and

FIG. 10 is a schematic block diagram illustrating one embodiment of a system for communication of notification in accordance with embodiments of the present disclosure.

### DETAILED DESCRIPTION

Aspects of the present disclosure may be embodied as a trailer light device configured to communicate with a remote display device. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

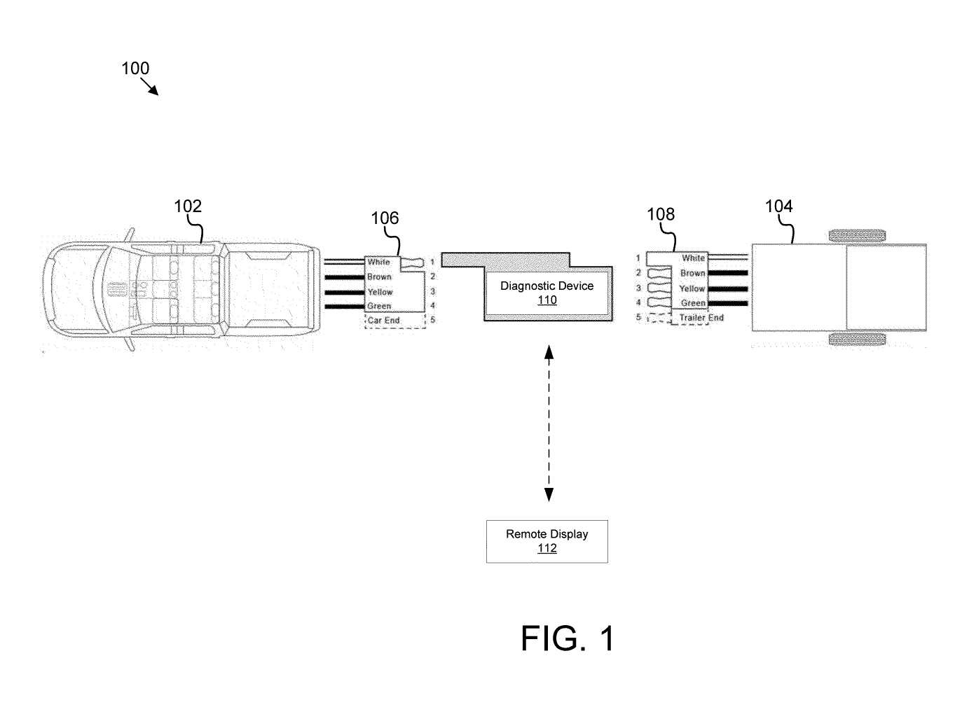

FIG. 1 illustrates one embodiment of a trailer light diagnostic system 100 in accordance with embodiments of the disclosure. In the depicted embodiment, a vehicle 102 is electrically coupled with a trailer 104. As described below with reference to embodiments of the disclosure, electrically coupling a vehicle to a trailer refers to coupling the electrical lighting system of the trailer 104 with the electrical lighting system of the vehicle 102. As known by those skilled in the art, vehicles 102 capable of towing trailers typically include a wiring harness 106 that is electrically coupled with the lighting/marking system of the vehicle 102. Stated differently, the wiring harness 106 is electrically coupled with the turn signals, brake signals, backup lights, etc., of the vehicle 102. Accordingly, a lighting/marking system of the trailer 104 may be electrically coupled with the vehicle 102 via the wiring harness 106. The trailer 104 includes a plug 108 that is configured for interfacing with the wiring harness 106.

The vehicle 102 may be any vehicle capable of towing a trailer. Examples include, but are not limited to, commercial towing vehicles, and non-commercial towing vehicles. The depicted vehicle 102 is a non-commercial example of a towing vehicle that is capable of towing the trailer 104. Similarly, the trailer 104 may be a commercial or a non-commercial trailer.

In one embodiment, the wiring harness 106 is a 4-wire wiring harness. The 4-wire wiring harness, as is known by those of skill in the art, includes 4 pins that allow for the transfer of power for lighting and auxiliary functions of the trailer 104 including, but not limited to, brake control, backup lights, or 12V power for interior lights, etc. Common 4-wire wiring harnesses include pins for right and left turn signals, marker lights, and ground. Although depicted here as a 4-wire wiring harness, embodiments of the disclosure may be adapted for use with 5, 6, 7, and more pins.

The system 100, in one embodiment, includes a diagnostic device 110 for determining a status of an electrical signal between the vehicle 102 and the trailer 104. The diagnostic device 110 is configured to communicate the status of the electrical signal with a remote display 112 via a communication path or network. In an embodiment, the remote display 112 comprises a smartphone device. The remote display 112 may further include an application configured for receiving, rendering, and displaying the data associated with the status of the electrical signal. Additionally, the remote display 112 may include a receiver configured to operate according to a short- or a long-range communication protocol.

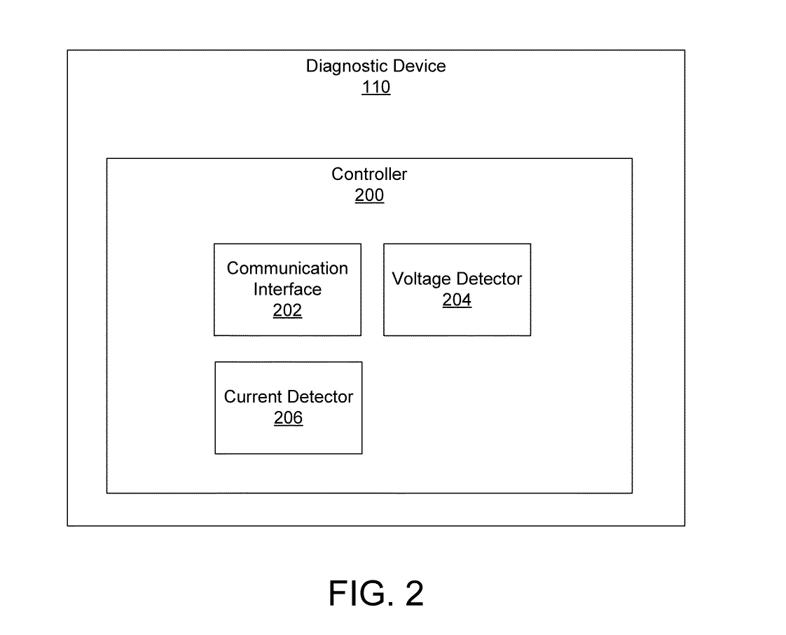

FIG. 2 is a schematic block diagram illustrating one embodiment of a diagnostic device 110 in accordance with embodiments of the disclosure. The diagnostic device 110, in one embodiment, includes circuitry (including, in one embodiment, a processor and memory) to implement a controller 200 from code or instructions. The controller 200 is configured for analyzing electrical signals of trailer wiring and communicating the analysis with the remote display 112 as described above.

In one embodiment, the controller 200 includes a communication interface 202 for communicating with the remote display 112. The communication interface 202 may be configured for sending electrical signal status updates to the remote device 112. In another embodiment, the communication interface 202 is configured for receiving commands, mode selections, control commands, etc., from the remote display 112.

In an embodiment, the communication interface 202 is a Bluetooth transceiver. In another embodiment, the communication interface 202 is a ZigBee interface. In still another embodiment, the communication interface 202 is a Wi-Fi interface. One of ordinary skill will recognize alternative embodiments, such as WiMAX, mobile data link, etc. The communication interface 202 may be configured to connect to a network. Alternatively, the communication interface 202 may be configured to establish a direct peer-to-peer connection with the remote display 112.

In one embodiment, the controller 200 also includes a voltage detector 204. The voltage detector 204 is coupled with each of the pins (or wires) of the wiring harness 106 and configured to determine the voltage of each wire. In most vehicles, the operating voltage of the vehicle is in the range of 0 and about 14 volts. The voltage detector is configured to identify when a wire is energized and when the wire is not energized. When a wire is energized, the corresponding accessory (e.g., blinker, brake light, winch, etc.) is also energized. The controller 200 is configured to determine when the accessory is energized and communicate the state (e.g., on or off) with the remote display 112. In one embodiment, the voltage detector 204 also includes circuitry to step-down the voltage of the wire to a voltage that is suitable for the controller 200. One example of such circuitry includes a Zener diode that acts to shift the voltage by a quantity that is equal to the Zener diode's breakdown voltage.

In one embodiment, the controller 200 includes a current detector 206. The current detector 206 may also be coupled with the wires of the wiring harness 106 to determine when a current in a wire has changed. This is useful for determining when a light bulb, for example, has burned out. Stated another way, the current detector 206 is configured to detect a change in normal current usage, and indicate to the remote display 112 that a problem may exist related to the wire with the detected change.

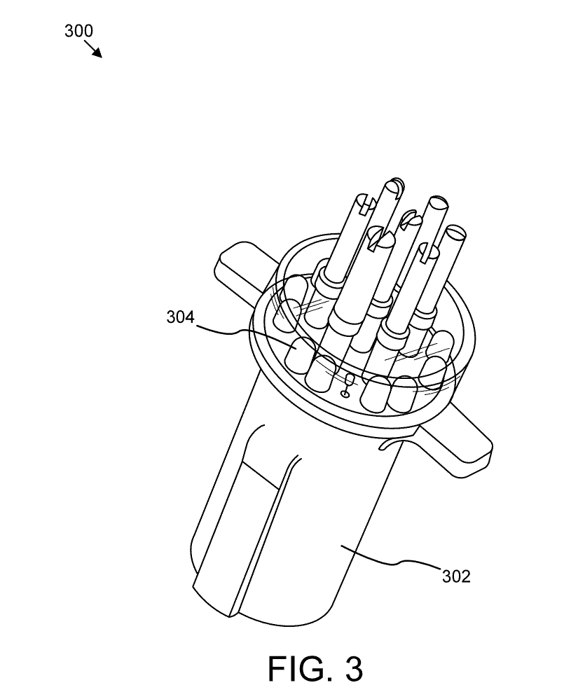

FIG. 3 is a perspective view diagram illustrating one embodiment of a diagnostic device 300 in accordance with embodiments of the disclosure. In one embodiment, the diagnostic device 300 includes a housing 302 that is formed with an external shape that is configured for interfacing with the wiring harness 106 of FIG. 1. Although the wiring harness of FIG. 1 is depicted as a 4-wire wiring harness, the diagnostic device may be implemented, as depicted, a 7-wire wiring harness. In another embodiment, the diagnostic device 300 may include visual indicators 304 that are configured to indicate when one of the wires or pins is energized. For example, a visual indicator may blink along with the right blinker of the vehicle. Simultaneously, the status of the wire or pin may be communicated to the remote display 112. As such, both the visual indicator 304 and the remote display 112 may “blink” along with the blinker of the car. This beneficially helps a driver of the vehicle determine if the electrical system of the vehicle is functioning properly.

The diagnostic device 300, as with the other described embodiments of the diagnostic device, functions as a pass-through device. In other words, the diagnostic device 300 is coupled between the wiring harness of the vehicle and the wire plug of the trailer. Alternatively, the diagnostic device 300 merely plugs into the vehicle and functions to diagnose electrical problems of the vehicle. The diagnostic device 300 is configured to monitor the status of the electrical wires without interfering with the electrical signal to the accessory of the trailer. Stated differently, the accessory (e.g., brake light, electrical brake, etc.) continues to function normally.

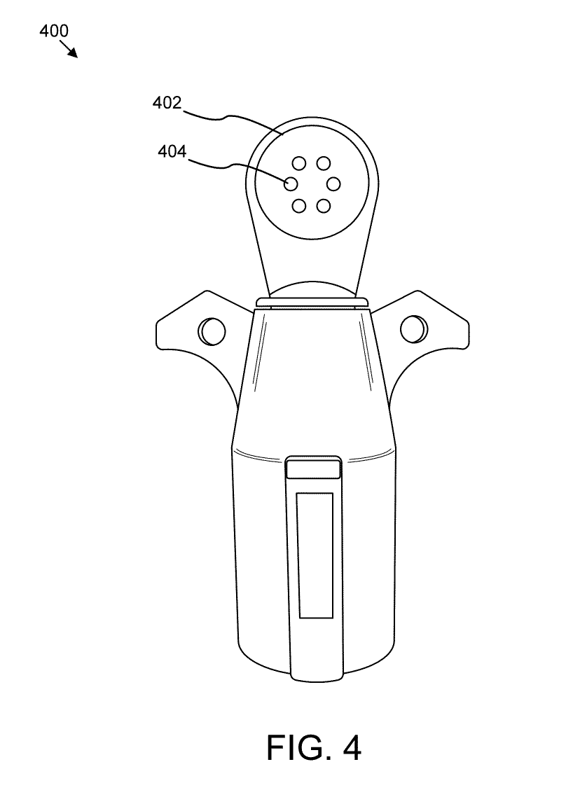

FIG. 4 is a side view diagram illustrating one embodiment of a diagnostic device 400 in accordance with embodiments of the disclosure. The diagnostic device 400 may include a removable visual indicator device 402. The visual indicator device 402 may include a plurality of visual indicators 404 that are insertable into the diagnostic device, as depicted. Accordingly, the diagnostic device 400 may be utilized for diagnosing the electrical wiring of the vehicle without the presence of a trailer.

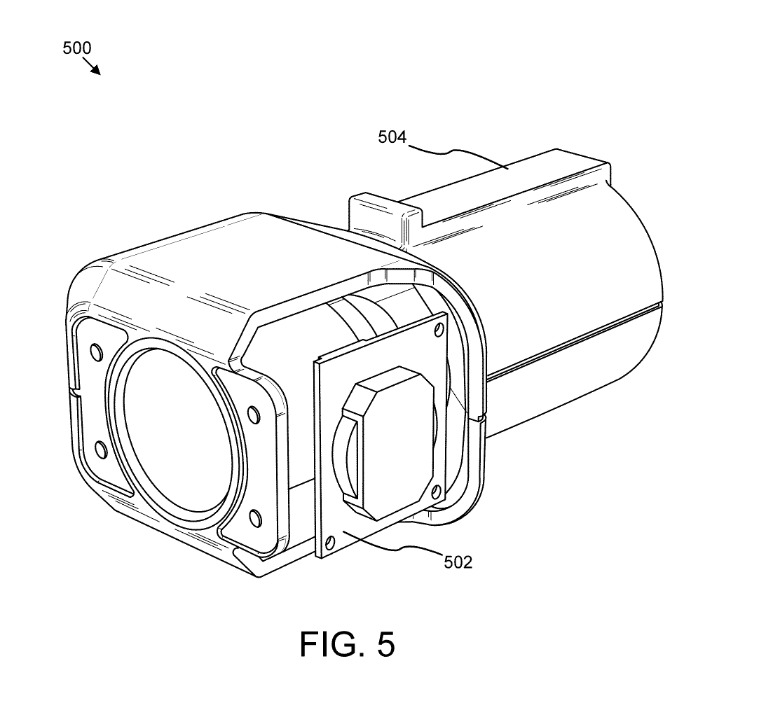

FIG. 5 is a perspective view diagram illustrating one embodiment of a housing in accordance with embodiments of the disclosure. The housing, in one embodiment, is configured with a removable portion (not shown) to enable access to the controller 502. The controller 502, in one embodiment, as described above, includes circuitry for analyzing the electrical trailer wires of a vehicle.

The housing is configured for engaging the wiring harness of a vehicle. The exterior shape of the male end of the housing 500, therefore, includes a profile that is common to a predetermined wiring harness. For example, all 6-wire wiring harnesses typically have a ridge 504 for engaging a slot in the wiring harness of the vehicle. Other profiles may be selected according the type of wiring harness of the vehicle (i.e., 4 pin, 6 pin, 7 pin, European style, etc.).

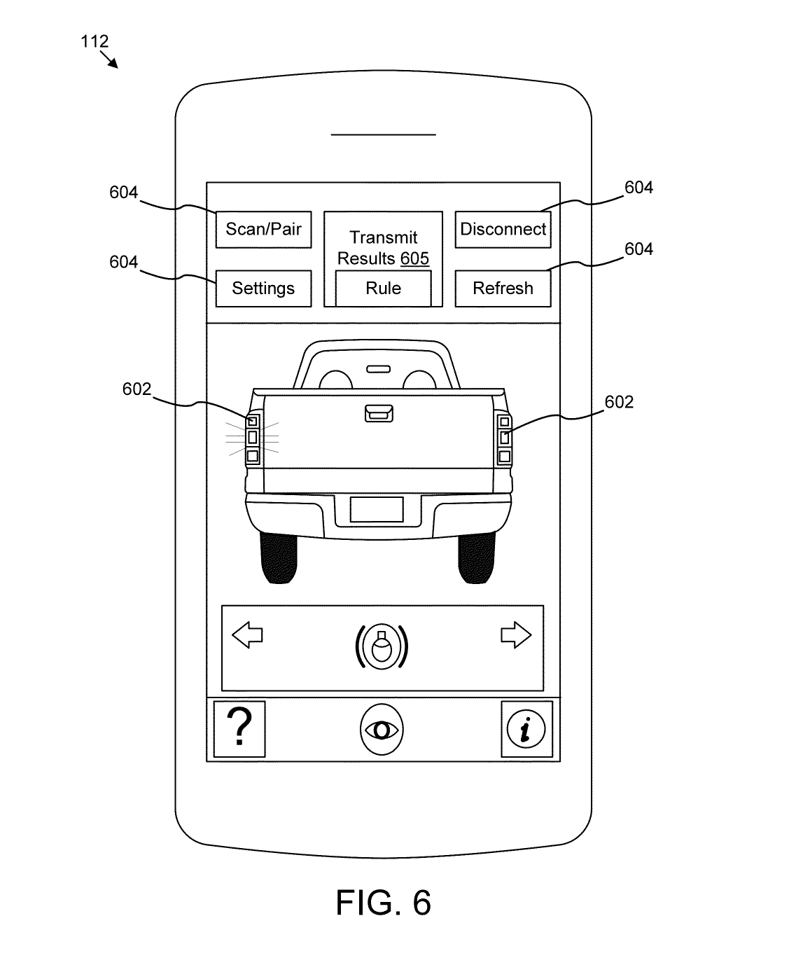

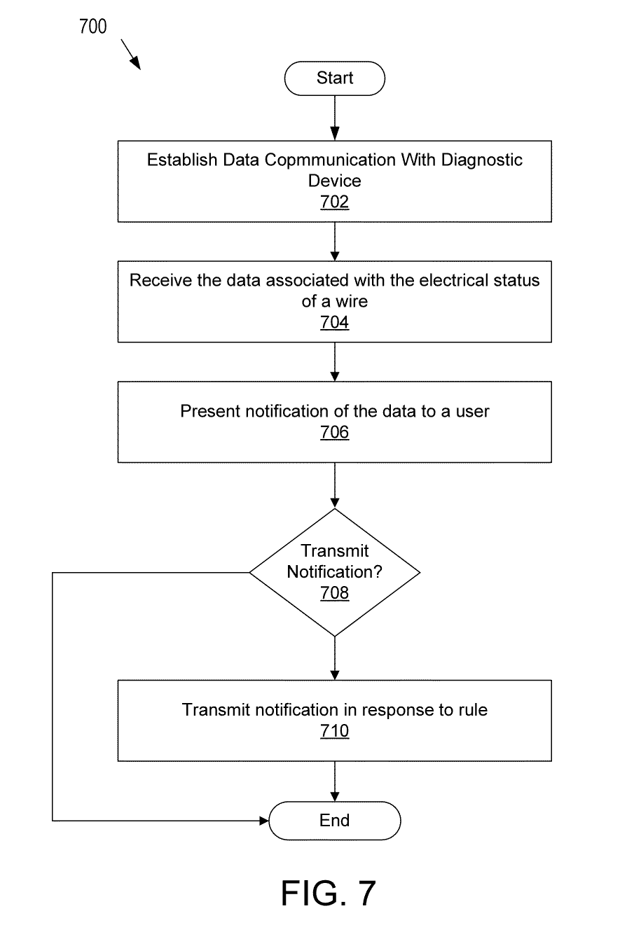

FIG. 6 is a block diagram illustrating one embodiment of a user interface of a remote display 112 in accordance with embodiments of the disclosure. The user interface, in one embodiment, is generated by a processing device coupled with a memory device. The memory device stores instructions capable of causing the processing device to generate the user interface. The processing device, in one embodiment is configured to communicate with the diagnostic device described above with reference to FIGS. 1-5. The processing device, as described in greater detail below with reference to FIG. 7, is configured to receive wire state information (e.g., on or off) and present the state information to a user via the user interface. For example, if the processing device receives an indication that the left blinker is activated, the processing device is configured to cause a representative image of the left blinker 602 to blink also.

In a further embodiment, the processing device is configured to transmit state information to a recipient. The user may initiate this transmission via a button 605. Alternatively, the state information transmission may be initiated automatically in response to a rule or preference. In other words, a rule or preference may require that a notification be sent when an electrical system failure is detected (i.e., a blinker fails to activate). Other examples of rules include, but are not limited to, a rule that requires a notification every predetermined time interval (e.g., once a week), a rule that requires a notification for every predetermined distance interval (e.g., every 5000 miles), etc. In one embodiment, the processing device is configured to communicate the notification as an email to a predetermined recipient, or alternatively to communicate the notification as an update that is transmitted to a website, database, or other data repository.

The user interface may include a visual depiction of the rear end of the vehicle. The user interface may include visual indicators 602 that correspond with the turn, reverse, and brake lights of the vehicle. The remote display 112, as described above, is configured to communicate with the controller and receive status updates for the electrical wires/pins that correspond with the turn, reverse, and brake lights of the vehicle. The remote display 112 is configured to visually indicate to a user that a light on the vehicle is being energized. The user interface may also include buttons 604 for scanning/pairing with the diagnostic device.

FIG. 7 illustrates one embodiment of a method 700 for a diagnostic device. The method is performed by processing logic that may comprise hardware (circuitry, dedicated logic, etc.), software (such as is run on a general purpose computer system or a dedicated machine), or a combination of both. In one embodiment, the method is performed by a processing device coupled with the remote display.

In an embodiment, the method 700 begins, and the logic establishes a data communication channel with a diagnostic device, as shown at block 702. In one example, establishing a data communication channel comprises establishes a connection via a wireless protocol (i.e., Wi-Fi, Bluetooth, etc.) as described above. At block 704, the logic receives data indicative of an electrical status or state of a wire in the vehicle lighting system. For example, the logic may receive an indication that the wire that energizes the left blinker is flashing between an energized state and a not-energized state.

At block 706, the logic presents a notification of the electrical status of the wire to the user. In one embodiment, the logic presenting a notification of the electrical status of the wire to the user comprises causing a representation of a vehicle to “blink” in response to an indication that the left or right blinker is blinking. In a similar manner, the logic may cause the graphical representation of the vehicle to illuminate brake lights, hazard lights, etc. In an alternative embodiment, the logic presents a notification of the electrical status of the wire to the user via an aural notification. This is beneficial where the user is driving the vehicle and not wanting to be distracted by visual notification on the remote display.

If, at block 708 the logic determines that a notification should be transmitted to a recipient, the logic transmits the notification. In one embodiment, the logic determining that a notification should be sent comprises processing at least one of the rules and in response to a determination that a rule has been met, transmitting the notification at block 710. For example, the logic may determine that a predetermined time or distance interval has been met, or a rule requiring a notification upon a failure has been met. In another embodiment, the logic determines that a notification should be sent when a user presses a button that corresponds to a command to transmit a notification. The logic, as discussed above, is configured to transmit the notification via email, SMS, or other notification.

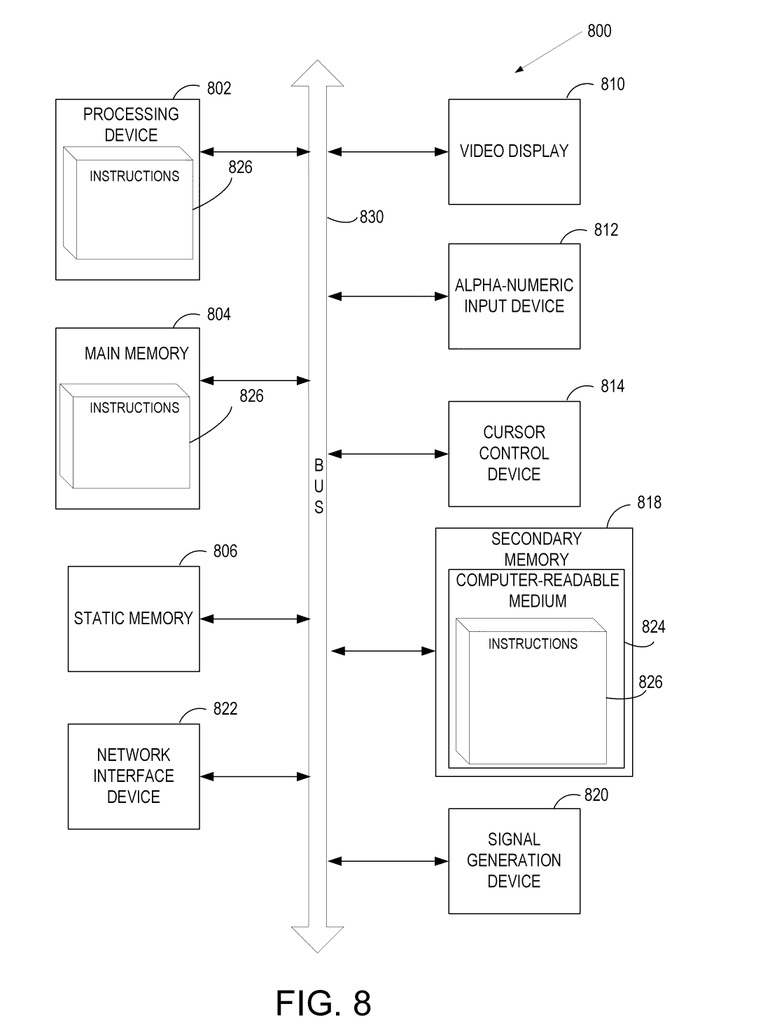

FIG. 8 is a diagram of one embodiment of a computer system for a remote display. Within the computer system 800 is a set of instructions for causing the machine to perform any one or more of the methodologies discussed herein. In alternative embodiments, the machine may be connected (e.g., networked) to other machines in a LAN, an intranet, an extranet, or the Internet. The machine may be a host in a cloud, a cloud provider system, a cloud controller or any other machine. The machine may operate in the capacity of a server or a client machine in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 800 includes a processing device 802, a main memory 804 (e.g., read-only memory (ROM), flash memory, dynamic random access memory (DRAM) such as synchronous DRAM (SDRAM) or DRAM (RDRAM), etc.), a static memory 806 (e.g., flash memory, static random access memory (SRAM), etc.), and a secondary memory 818 (e.g., a data storage device in the form of a drive unit, which may include fixed or removable computer-readable storage medium), which communicate with each other via a bus 830.

The processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute the instructions 826 for performing the operations and steps discussed herein.

The computer system 800 may further include a network interface device 822. The computer system 800 also may include a video display unit 810 (e.g., a liquid crystal display (LCD) or a cathode ray tube (CRT)) connected to the computer system through a graphics port and graphics chipset, an alphanumeric input device 812 (e.g., a keyboard), a cursor control device 814 (e.g., a mouse), and a signal generation device 820 (e.g., a speaker).

The secondary memory 818 may include a machine-readable storage medium (or more specifically a computer-readable storage medium) 824 on which is stored one or more sets of instructions 826 embodying any one or more of the methodologies or functions described herein. In one embodiment, the instructions 826 include instructions for the target application or mobile app. The instructions 826 may also reside, completely or at least partially, within the main memory 804 and/or within the processing device 802 during execution thereof by the computer system 800. The main memory 804 and the processing device 802 also constituting machine-readable storage media.

The computer-readable storage medium 824 or computer storage device may also be used to store the instructions 826 persistently. While the computer-readable storage medium 824 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The instructions 826, components and other features described herein can be implemented as discrete hardware components or integrated in the functionality of hardware components such as ASICS, FPGAs, DSPs or similar devices. In addition, the instructions 826 can be implemented as firmware or functional circuitry within hardware devices. Further, the instructions 826 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “providing,” “generating,” “detecting,” “identifying,” “storing,” “receiving,” “sending,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

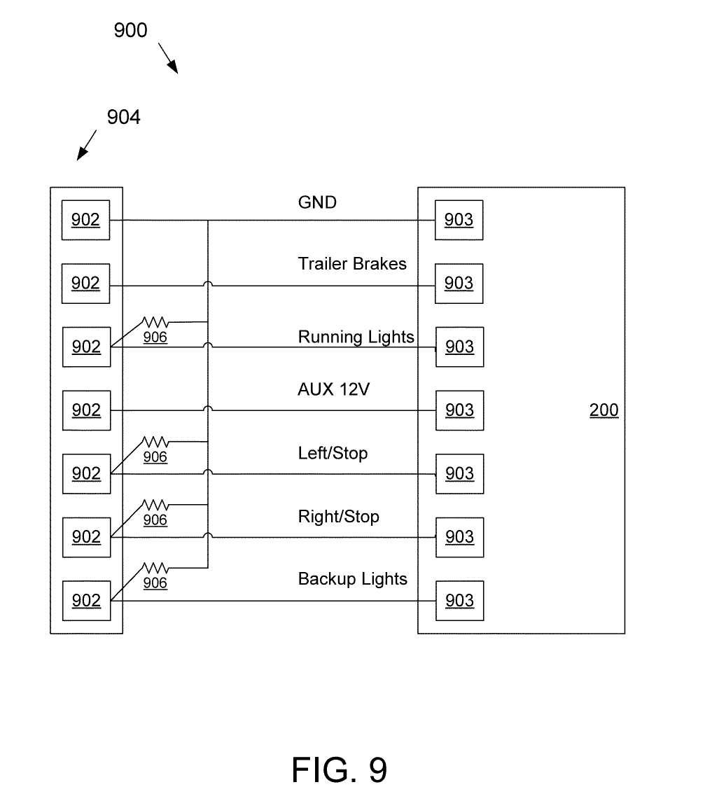

FIG. 9 is a schematic block diagram illustrating one embodiment of a circuit 900 in accordance with embodiments of the present disclosure. The circuit 900 is a representative embodiment of the connection between the controller 200 and the wiring harness 904. The controller, as described above, includes a plurality of inputs 903 for receiving detecting voltage and/or current in the wiring harness 904. In the depicted embodiment, the circuit 900 includes contact points 902 that are representative of wires in a vehicle lighting system. In the depicted embodiment, the vehicle lighting system includes 7 wires identified as GND, Trailer Brakes, Running Lights, AUX 12v, Left/Stop, Right/Stop, and Backup Lights. Different wiring systems may include a greater or lesser number of wires. Box 904 is indicative of the wiring connector that plugs into the vehicle lighting wiring harness.

Certain late model vehicles include logic to detect when a trailer has been connected to the vehicle. Certain functions of the vehicle will fail to operate properly if a trailer is not detected, such as a trailer brake. Beneficially, the circuit 900 includes, in one embodiment, at least one resistor 906 wired between a contact point 902 and the GND wire. The added load causes the vehicle to identify the circuit 900 as a trailer, and thereby enable the additional functions. In another embodiment, the circuit 900 includes a plurality of resistors, each of the plurality of resistors 906 coupling a corresponding contact point with GND (i.e., vehicle frame) or the GND wire. In one embodiment, each resistor 906 has a resistance of 1000 Ohms. Although a single resistor 906 may be implemented and coupled to one or more of the contact points 902, in one embodiment multiple resistors (as depicted) allows for better heat dissipation.

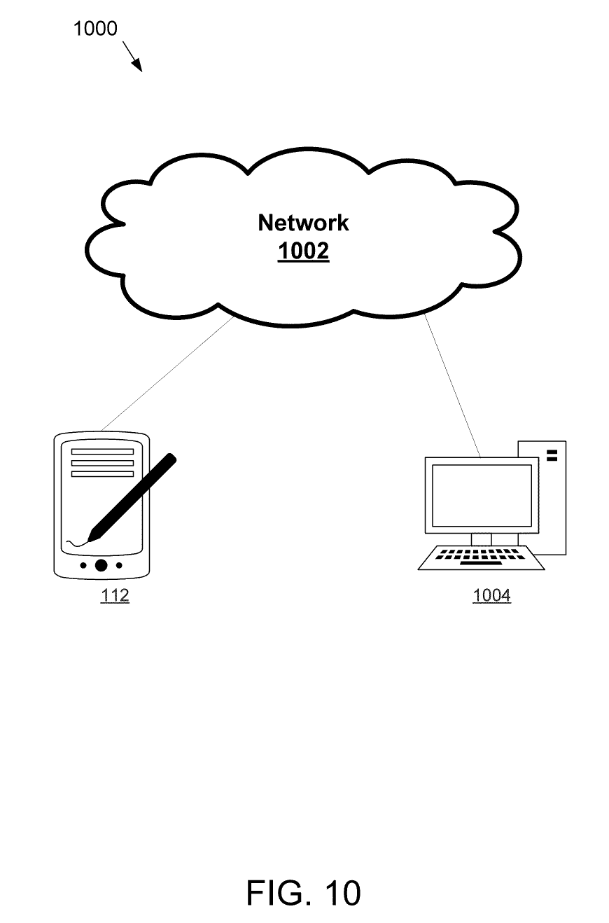

FIG. 10 is a schematic block diagram illustrating one embodiment of a system 1000 for communication of notification in accordance with embodiments of the present disclosure. In the depicted embodiment, the remote display 112 is configured to communicate over a network 1002 to a server 1004. In certain embodiments, the communication may be implemented as an email to a fleet manager, for example, or a data upload to a fleet management database.

In the preceding description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment. Like reference numbers signify like elements throughout the description of the figures.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A trailer light diagnostic device comprising:
a housing;
a controller disposed within the housing and configured for wirelessly communicating a status of an electrical wire of a vehicle lighting system with a remote display, where the controller is electrically coupled with the wire.

2. The trailer light diagnostic device of claim 1, where the housing comprises an exterior profile configured for inserting into a wiring harness of the vehicle.

3. The trailer light diagnostic device of claim 1, where the controller comprises a communication interface configured for transmitting the status of the electrical wire.

4. The trailer light diagnostic device of claim 1, where the controller comprises a voltage detector configured to detect a voltage of the electrical wire.

5. The trailer light diagnostic device of claim 1, where the controller comprises a current detector configured to detect a current of the electrical wire.

6. The trailer light diagnostic device of claim 1, where the remote display is configured to generate a user interface that includes a depiction of a vehicle.

7. The trailer light diagnostic device of claim 6, where the remote display is further configured to generate an indication of the status of the electrical wire.

8. The trailer light diagnostic device of claim 7, where the indication of the status of the electrical wire is a visual notification displayed as a flashing light on the depiction of the vehicle.

9. The trailer light diagnostic device of claim 7, where the indication of the status of the electrical wire is an aural notification.

10. A remote display device including at least one computing device and at least one software module that are together configured for performing actions, where the at least one computing device includes a processor and a memory, the actions comprising:
establishing a wireless data connection with a trailer light diagnostic device;
receiving, from the trailer light diagnostic device, data indicative of a electrical status of a wire in a trailer light system; and
presenting, in response to the electrical status of the wire, a notification to a user.

11. The remote display of claim 10, where the actions further comprise generating a user interface that includes a depiction of a vehicle.

12. The remote display of claim 11, where the actions further comprise generating a visual notification of the notification and displaying the visual notification as a flashing light on the depiction of the vehicle.

13. The remote display of claim 11, where the actions further comprise generating an aural notification.

14. The remote display of claim 10, where the actions further comprise analyzing at least one rule indicative of a requirement to transmit a notification to a target device.

15. The remote display of claim 14, where the actions further comprise transmitting, in response to an indication to transmit a notification, a notification to the target device.

16. The remote display of claim 15, where the notification comprises an email.

17. A trailer light diagnostic system comprising:
a controller disposed within a housing and configured for wirelessly communicating a status of an electrical wire of a vehicle lighting system with a remote display, where the controller is electrically coupled with the wire; and
where the remote display includes at least one computing device and at least one software module that are together configured for performing actions, where the at least one computing device includes a processor and a memory, the actions comprising:
establishing a wireless data connection with a trailer light diagnostic device;
receiving, from the trailer light diagnostic device, data indicative of a electrical status of a wire in a trailer light system; and
presenting, in response to the electrical status of the wire, a notification to a user.

18. The trailer light diagnostic system of claim 17, where the controller comprises a voltage detector configured to detect a voltage of the electrical wire.

19. The trailer light diagnostic system of claim 17, where the controller comprises a current detector configured to detect a current of the electrical wire.

20. The trailer light diagnostic system of claim 17, where the actions further comprise generating a user interface that includes a depiction of a vehicle.
